(19) United States
(12) Patent Application Publication
(10) Pub. No.: US 2008/0212682 A1
(43) Pub. Date: Sep. 4, 2008

(54) Reduced resolution video transcoding with greatly reduced complexity

(76) Inventor: Hari Kalva, Delray Beach, FL (US)

Correspondence Address: MARTIN NOVACK, 16355 VINTAGE OAKS LANE, DELRAY BEACH, FL, 33484, US

(21) Appl. No.: 12/011,479

(22) Filed: Jan. 25, 2008

Related U.S. Application Data
(60) Provisional application No. 60/897,353, filed on Jan. 25, 2007.
(60) Provisional application No. 60/995,843, filed on Sep. 28, 2007.

(51) Int. Cl. H04N 7/26

(52) U.S. Cl. 375/240.21; 375/E07.198

(57) ABSTRACT

A method for receiving encoded MPEG-2 video signals and transcoding the received encoded signals to encoded H.264 reduced resolution video signals, including the following steps: decoding the encoded MPEG-2 video signals to obtain frames of uncompressed video signals and to also obtain MPEG-2 feature signals; deriving H.264 mode estimation signals from the MPEG-2 feature signals; subsampling the frames of uncompressed video signals to produce subsampled frames of video signals; and producing the encoded H.264 reduced resolution video signals using the subsampled frames of video signals and the H.264 mode estimation signals.

### RELATED APPLICATION

Priority is claimed from U.S. Provisional Patent Application No. 60/897,353, filed Jan. 25, 2007, and from U.S. Provisional Patent Application No. 60/995,843, filed Sep. 28, 2007, and said U.S. Provisional Patent Applications are incorporated by reference. Subject matter of the present Application is generally related to subject matter in copending U.S. Patent Application Ser. No. ______, filed of even date herewith, and assigned to the same assignee as the present Application.

### FIELD OF THE INVENTION

This invention relates to transcoding of video signals and, more particularly, to reduced resolution transcoding, with greatly reduced complexity, for example reduced resolution MPEG-2 to H.264 transcoding, with high compression and greatly reduced complexity.

### BACKGROUND OF THE INVENTION

MPEG-2 is a coding standard of the Motion Picture Experts Group of ISO that was developed during the 1990's to provide compression support for TV quality transmission of digital video. The standard was designed to efficiently support both interlaced and progressive video coding and produce high quality standard definition video at about 4 Mbps. The MPEG-2 video standard uses a block-based hybrid transform coding algorithm that employs transform coding of motion-compensated prediction error. While motion compensation exploits temporal redundancies in the video, the DCT transform exploits the spatial redundancies. The asymmetric encoder-decoder complexity allows for a simpler decoder while maintaining high quality and efficiency through a more complex encoder. Reference can be made, for example, to ISO/IEC JTC11/SC29/WG11, “Information technology—Generic Coding of Moving Pictures and Associated Audio Information: Video”, ISO/IEC 13818-2:2000, incorporated by reference.

The H.264 video coding standard (also known as Advanced Video Coding or AVC) was developed, more recently, through the work of the International Telecommunication Union (ITU) video coding experts group and MPEG (see ISO/IEC JTC11/SC29/WG11, “Information Technology—Coding of Audio-Visual Objects—Part 10; Advanced Video Coding”, ISO/IEC 14496-10:2005., incorporated by reference). A goal of the H.264 project was to create a standard capable of providing good video quality at substantially lower bit rates than previous standards (e.g. half or less the bit rate of MPEG-2, H.263, or MPEG-4 Part 2), without increasing the complexity of design so much that it would be impractical or excessively expensive to implement. An additional goal was to provide enough flexibility to allow the standard to be applied to a wide variety of applications on a wide variety of networks and systems. The H.264 standard is flexible and offers a number of tools to support a range of applications with very low as well as very high bitrate requirements. Compared with MPEG-2 video, the H.264 video format achieves perceptually equivalent video at ⅓ to ½ of the MPEG-2 bitrates. The bitrate gains are not a result of any single feature but a combination of a number of encoding tools. However, these gains come with a significant increase in encoding and decoding complexity.

The H.264 standard is intended for use in a wide range of applications including high quality and high-bitrate digital video applications such as DVD and digital TV, based on MPEG-2, and low bitrate applications such as video delivery to mobile devices. However, the computing and communication resources of the end user terminals make it impossible to use the same encoded video content for all applications. For example, the high bitrate video used for a digital TV broadcast cannot be used for streaming video to a mobile terminal. For delivery to mobile terminals, one needs video content that is encoded at lower bitrate and lower resolution suitable for low-resource mobile terminals. Pre-encoding video at a few discrete bitrates leads to inefficiencies as the device capabilities vary and pre-encoding video bitstreams for all possible receiver capabilities is impossible. Furthermore, the receiver capabilities such as available CPU, available battery, and available bandwidth may vary during a session and a pre-encoded video stream cannot meet such dynamic needs. To make full use of the receiver capabilities and deliver video suitable for a receiver, video transcoding is necessary. A transcoder for such applications takes a high bitrate video as input and transcodes it to a lower bitrate and/or lower resolution video suitable for a mobile terminal.

Several different approaches have been proposed in the literature. A fast DCT-domain algorithm for down-scaling an image by a factor of two has been proposed (see Y. Nakajima, H. Hori and T. Kaknoh, “Rate Conversion Of MPEG Coded Video By Re-Quantization Process”, Proceedings of the IEEE International Conference on Image Processing, ICIP'95, 3, 408-411, Washington, DC, USA, October 1995). This algorithm makes use of predefined matrices to do the down sampling in the DCT domain at fairly good quality and low complexity.

In addition, down-sampling filter may be used between the decoding and the re-encoding stages of the transcoder, as proposed by Bjork et al. (see N. Bjork and C. Chisopoulos, “Transcoder Architectures For Video Coding”, IEEE Transactions On Consumer Electronics, 44, no. 1, pp. 88-98, February 1998). The objective with this approach is to clearly down sample the incoming video in order to reduce its bitrate. This is necessary when large resolution video is delivered to end-users who have limited display capabilities. In this case, reducing the resolution of the video frame size allows for the successful delivery and display of the requested video material. The proposal also includes a solution to solve the problem of included intra Macroblocks (MBs). If at least one Intra macroblocks exists among the four selected macroblocks, an Intra type is selected. If there are no Intra macroblocks and at least one Inter macroblock, a P type MB is selected. If all the macroblocks are skipped then the MB is coded as skipped.

However, when the picture resolution is reduced by the transcoder, some quality impairment may be noticed as a result (see R. Morky and D. Anastassiou, “Minimal Error Drift In frequency Scalability For Motion Compensation DCT Coding”, IEEE International Conference In Image Processing, ICIP'98, 2, pp. 365-369, Chicago, USA, October 1998; and A. Vetro and H. Sun, “Generalized Motion Compensation For Drift Reduction”, Proceedings of the Visual Communication and Image Processing Annual Meeting”, VCIP'98, 3309, 484-495, San Hose, USA, January 1998). This quality degradation is accumulative similar to drift error. The main difference between this kind of artifact and the drift effect is that the former results from the down sampling inaccuracies, whereas the latter is a consequence of quantizer mismatches in the rate reduction process. To resolve this issue, Vetro et al. (supra) propose a set of filters to apply in order to optimize the motion estimation process. The filter applied varies depending on the resolution conversion to be used.

The motion compensation can be performed in the DCT domain and the down conversion can be applied on a macroblock by macroblock basis (see W. Zhu, K. H. Yang and M. J. Beacken, “CIF-to-OCIF Video Bit Stream Down-Conversation In The DCT Domain”, Bell Labs Technical Journal, 3, no. 3, pp. 21-29, Jul. 1998). Thus, all four luminance blocks are reduced to one block, and the chrominance blocks are left unchanged. Once the conversion is complete for four neighbouring macroblocks, the corresponding four chrominance blocks are also reduced to one (one individual block for Cb and one for Cr).

It is among the objects of the present invention to provide improvements in resolution reduction in the context of reduced complexity transcoding.

### SUMMARY OF THE INVENTION

The present invention uses certain information obtained during the decoding of a first compressed video standard (e.g. MPEG-2) to derive feature signals (e.g. MPEG-2 feature signals) that facilitate subsequent encoding, with reduced complexity, of the uncompressed video signals into a second compressed video standard (e.g. encoded H.264 video). This is advantageously done, in conjunction with reduced resolution, according to principles of the invention. Also, in embodiments hereof, a machine learning based approach, that enables reduction to multiple resolutions (e.g. multiples of 2), is used to advantage.

In accordance with a form of the invention, a method is provided for receiving encoded MPEG-2 video signals and transcoding the received encoded signals to encoded H.264 reduced resolution video signals, including the following steps: decoding the encoded MPEG-2 video signals to obtain frames of uncompressed video signals and to also obtain MPEG-2 feature signals; deriving H.264 mode estimation signals from said MPEG-2 feature signals; subsampling said frames of uncompressed video signals to produce subsampled frames of video signals; and producing said encoded H.264 reduced resolution video signals using said subsampled frames of video signals and said H.264 mode estimation signals.

In an embodiment of this form of the invention, the MPEG-2 feature signals comprise macroblock modes and motion vectors, and can also comprise DCT coefficients, and residuals.

In an embodiment of the invention, the step of deriving H.264 mode estimation signals from said MPEG-2 feature signals comprises providing a decision tree which receives said MPEG-2 feature signals and outputs said H.264 mode estimation signals, and the decision tree is configured using a machine learning method.

A feature of an embodiment of the invention comprises reducing the number of mode estimation signals derived from said MPEG-2 feature signals, and the reduction in mode estimation signals is substantially in correspondence with the reduction in resolution resulting from the subsampling.

In an embodiment of the invention, called mode reduction in the input domain, the reducing of the number of mode estimation signals is implemented by deriving a reduced number of mode estimation signals from a reduced number of MPEG-2 feature signals. In a form of this embodiment the deriving of the reduced number of MPEG-2 feature signals is implemented by using a subsampled residual from the decoding of the MPEG-2 video signals.

In another embodiment of the invention, called mode reduction in the output domain, the reducing of the number of mode estimation signals is implemented by deriving an initial unreduced number of mode estimation signals, and then reducing said initial unreduced number of mode estimation signals.

The invention also has general application to transcoding between other encoding standards with reduced resolution. In this form of the invention, a method is provided for receiving encoded first video signals, encoded with a first encoding standard, and transcoding the received encoded signals to reduced resolution second video signals, encoded with a second encoding standard, including the following steps: decoding the encoded first video signals to obtain frames of uncompressed video signals and to also obtain first feature signals; deriving second encoding standard mode estimation signals from said first feature signals; subsampling said frames of uncompressed video signals to produce subsampled frames of video signals; and producing said encoded reduced resolution second video signals using said subsampled frames of video signals and said second encoding standard mode estimation signals. In an embodiment of this form of the invention, the step of deriving second encoding standard mode estimation signals from said first feature signals comprises providing a decision tree which receives said first feature signals and outputs said second encoding standard mode estimation signals. The decision tree is configured using a machine learning method.

Further features and advantages of the invention will become more readily apparent from the following detailed description when taken in conjunction with the accompanying drawings.

### BRIEF DESCRIPTION OF THE DRAWINGS

FIG. 1 is a block diagram of an example of the type of system that can be used in conjunction with the invention.

FIG. 2 is a diagram illustrating resolution reduction by a factor of two.

FIG. 3 is a diagram illustrating (a) mode reduction in the input domain (MRID) and (b) mode reduction in the output domain (MROD).

FIG. 4 is a block diagram of a reduced resolution transcoder with mode reduction.

FIG. 5 is a diagram of routine that can be used for the training/configuring stage, including building a decision tree, for reduced resolution Intra macroblock encoding, for MRID, in accordance with an embodiment of the invention.

FIG. 6 is a diagram of a routine that can be used for the reduced resolution operating/encoding stage of a process, including using decision trees for speeding up Intra macroblock encoding, for MRID, in accordance with an embodiment of the invention.

FIG. 7 and 8 are diagrams of routines that can be used for the training/configuring stage, including building decision trees, for reduced resolution Intra macroblock encoding, for MROD, in accordance with an embodiment of the invention.

FIG. 9 is a diagram of a routine that can be used for the reduced resolution operating/encoding stage of a process, including using decision trees for speeding up Intra macroblock encoding, for MROD, in accordance with an embodiment of the invention.

### DETAILED DESCRIPTION

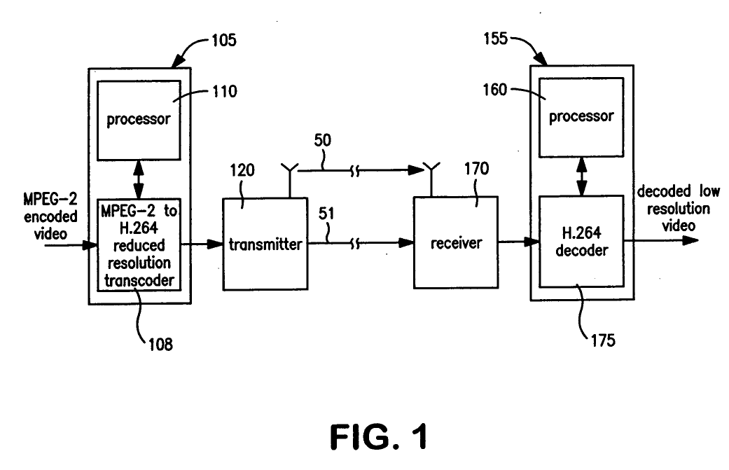

FIG. 1 is a block diagram of an example of the type of systems that can be advantageously used in conjunction with the invention. Two processor-based subsystems 105 and 155 are shown as being in communication over a channel or network, which may include, for example, any wired or wireless communication channel such as a broadcast channel 50 and/or an internet communication channel or network 51. The subsystem 105 includes processor 110 and the subsystem 155 includes processor 160. When programmed in the manner to be described, the processor subsystems 105 and/or 155 and their associated circuits can be used to implement embodiments of the invention. Also, it will be understood that plural processors can be used at different times in performing different functions. The processors 110 and 160 may each be any suitable processor, for example an electronic digital processor or microprocessor. It will be understood that any programmed general purpose processor or special purpose processor, or other machine or circuitry that can perform the functions described herein, can be utilized. The subsystems 105 and 155 will typically include memories, clock, and timing functions, input/output functions, etc., all not separately shown, and all of which can be of conventional types. The memories can hold any required programs.

In an example of a FIG. 1 application, the subsystems 105 and 155 can be parts of respective cell phones or other hand-held devices in communication with each other. MPEG-2 encoded video input to subsystem 105 is transcoded, using the principles of the invention, by transcoder 108, at reduced resolution, to H.264, which, in this example, is communicated to the device containing subsystem 155, which operates to decode the H.264 signals, using decoder 175, e.g. for display on the low resolution display of the device, or other use. The transcoder 108, to be described, can be implemented in hardware, firmware, software, combinations thereof, or by any suitable means, consistent with the principles hereof. In a similar vein, the block 108 can, for example, stand alone, or be incorporated into the processor 160, or implemented in any suitable fashion consistent with the principles hereof.

Applicant has observed that a key problem in spatial resolution reduction is the H.264 macroblock (MB) mode determination. Instead of evaluating the cost of all the allowed modes and then selecting the best mode, direct determination of MB mode has been used. Transcoding methods reported in my co-authored papers transcode video at the same resolution (see G. Fernandez-Escribino, H. Kalva, P. Cuenca, and L. Orozco-Barbosa, “RD Optimization For MPEG-2 to H.264 Transcoding,” Proceedings of the IEEE International Conference on Multimedia & Expo (ICME) 2006, pp. 309-312, and G. Fernandez-Escribino, H. Kalva, P. Cuenca, and L. Orozco-Barbosa, “Very Low Complexity MPEG-2 to H.264 Transcoding Using Machine Learning,” Proceedings of the 2006 ACM Multimedia conference, October 2006, pp. 931-940, both of which relate to machine learning used in conjunction with transcoding). While resolution reduction to any resolution is possible, reduction by multiples of 2 leads to optimal reuse of MB information from the decoding stage and gives the best performance. Resolution reduction by a factor of 2 in horizontal and vertical direction will be treated further.

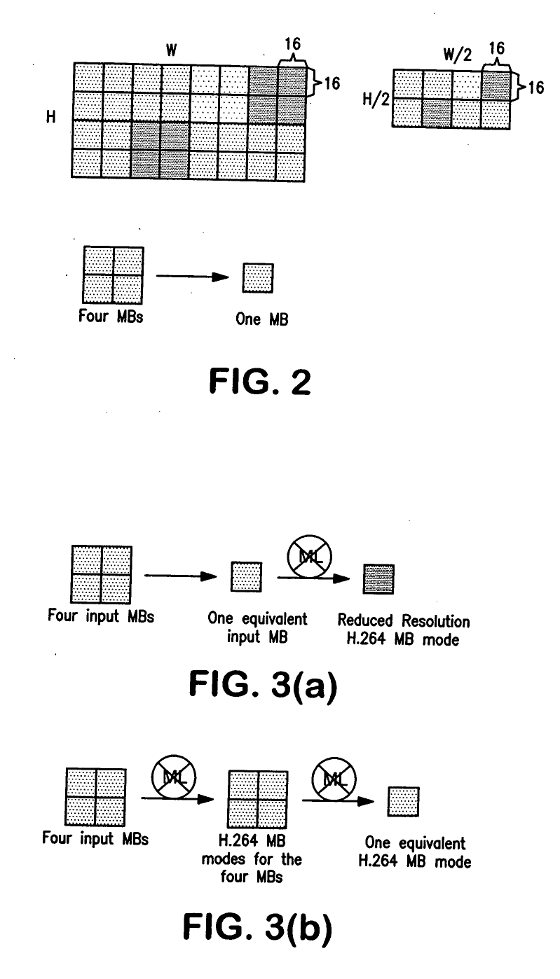

Four MBs in the input video result in one MB in the output video. The coding mode in the reduced resolution can be determined using the MPEG-2 information from all the input MBs. The techniques as described in the above-referenced papers on MPEG-2 to H.264 transcoding can be applied here to determine the H.264 MB modes. This approach, however, gives one H.264 mode for each MPEG-2 MB. For reduced resolution, one H.264 MB mode would be needed for four MPEG 2 MBs. FIG. 2 shows an example of resolution reduction. As seen in the Figure, four MBs in the input video result in one MB in the output video.

Mode determination for the reduced resolution video can be performed in two ways: 1) use the information from four MPEG-2 MBs to determine single H.264 modes and 2) determine H.264 MB modes for each of the MPEG-2 MBs, and then determine one H.264 MB mode from four H.264 MB modes. The former approach is referred to Mode Reduction in the Input Domain (MRID) and the later approach is referred to as Mode Reduction in the Output Domain (MROD). FIG. 3 shows the two approaches for resolution reduction in MPEG-2 to H.264 video transcoding. The “ML” symbol indicates that a machine learning process can be used.

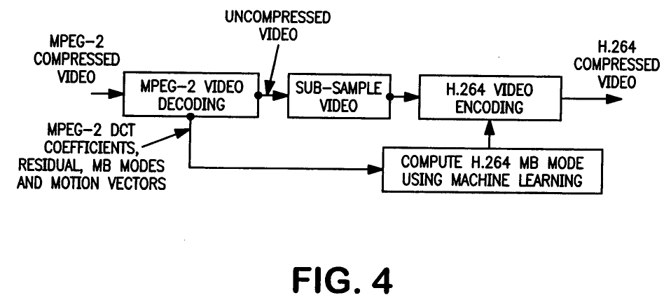

FIG. 4 shows the block diagram of the proposed pixel domain reduced resolution transcoder. The input video is decoded and MB information is collected for each MB. The decoded video is sub-sampled to the reduced resolution. The H.264 encoding stage is accelerated using the mode reduction in input domain (MRID) approach. The idea here is to reduce the MB information from the decoded MPEG-2 video (or other input video format) to the equivalent of one MB in the reduced resolution and then determine the H.264 MB mode from the reduced input information. MB information from four input MBs is reduced to the equivalent of one input MB. Based on the reduced input MB, the mode of the corresponding reduced resolution MB is then determined using approaches similar to the ones previously described.

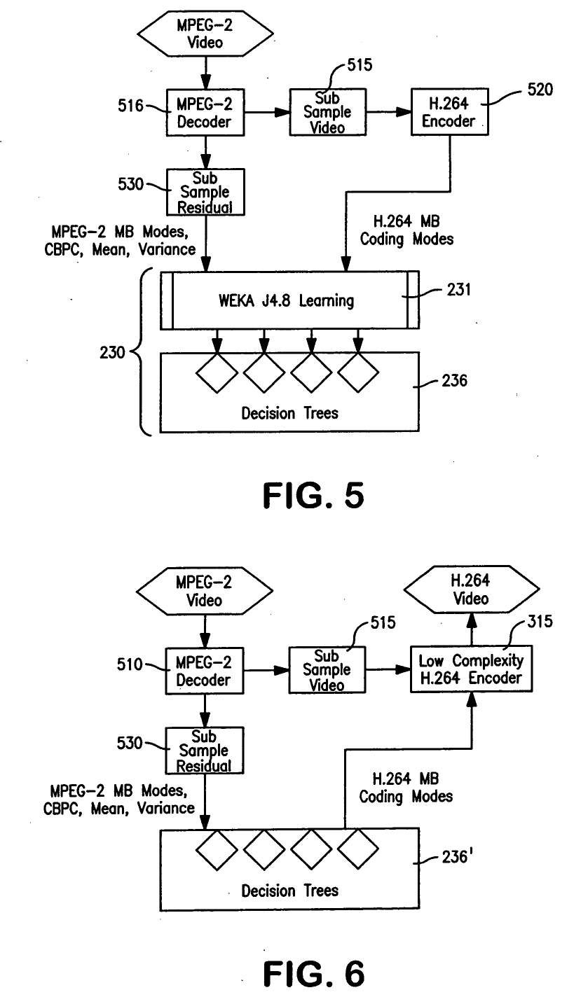

FIGS. 5 and 6 show the high level process for an embodiment of the invention. In the example of this embodiment, reduced complexity for intra macroblock (MB) coding and MRID are illustrated. FIG. 5 is a diagram of the learning/configuration stage for the machine learning of this embodiment, and FIG. 6 is a diagram of the operating/encoding stage for this embodiment. The encoded MPEG-2 video is decoded (block 510), and the decoded video is subsampled (block 515) and encoded with an H.264 encoder (block 520). Also, the MPEG-2 MB modes, mean and variance of the means of the subsample residual (block 530), together with the MB mode, for the current MB, as determined by a H.264 encoder, are input to a machine learning routine 230, which can be implemented, in this embodiment by Weka/J4.8. As is known in the machine learning art, a decision tree is made by mapping the observations about a set of data in a tree made of arcs and nodes. The nodes are the variables and the arcs the possible values for that variable. The tree can have more than one level; in that case, the nodes (leafs of the tree) represent the decision based on the values of the different variables that drives us from the root to the leaf. These types of trees are used in the data mining processes for discovering the relationship in a set of data, if it exits. The tree leafs are the classifications and the branches are the features that lead to a specific classification.

The decision tree of an embodiment hereof is made using the WEKA data mining tool. The files that are used for the WEKA data mining program are known as ARFF (Attribute-Relation File Format) files (see Ian H. Witten and Eibe Frank, “Data Mining: Practical Machine Learning Tools And Techniques”, 2^{nd} Edition, Morgan Kaufmann, San Francisco, 2005). An ARFF file is written in ASCII text and shows the relationship between a set of attributes. Basically, this file has two different sections; the first section is the header with the information about the name of the relation, the attributes that are used and their types; and the second data section contains the data. In the header section is the attribute declaration. Reference can be made to our co-authored publications G. Fernandez-Escribino, H. Kalva, P. Cuenca, and L. Orozco-Barbosa, “RD Optimization For MPEG-2 to H.264 Transcoding,” Proceedings of the IEEE International Conference on Multimedia & Expo (ICME) 2006, pp. 309-312, and G. Fernandez-Escribino, H. Kalva, P. Cuenca, and L. Orozco-Barbosa, “Very Low Complexity MPEG-2 to H.264 Transcoding Using Machine Learning,” Proceedings of the 2006 ACM Multimedia conference, October 2006, pp. 931-940, both of which relate to machine learning used in conjunction with transcoding. It will be understood that other suitable machine learning routines and/or equipment, in software and/or firmware and/or hardware form, could be utilized. The learning routing 230 is shown in FIG. 5 as comprising the learning algorithm 231 and decision tree(s) 236. The mode decisions subsequently made using the configured decision trees are used in the encoder instead of the actual mode search code that would conventionally be used in an H.264 encoder.

FIG. 6 shows the use of the configured decision trees 236′ to accelerate video encoding. In FIG. 6, uncompressed frames of video, after subsampling (block 515), are coupled with a modified encoder 315 which, in this embodiment, is a reduced complexity H.264 encoder. An example of a reduced complexity encoder, in the context of another decoder, is described in copending U.S. patent application Ser. No. 11/999,501, filed Dec. 5, 2007, and assigned to the same assignee as the present Application. As before, the computed statistical values output of block 530 are input to the configured decision tree 236′, which outputs the Intra MB mode and Intra prediction mode, which are then used by encoder 315, which is modified to use these modes instead of the normally derived corresponding modes, thereby saving substantial computation resource. The decision trees are just if-else statements and have negligible computational complexity. Depending on the decision tree, the mean values used are different. The set of decision trees used in the H.264 Intra MB coding are used in a hierarchy to arrive at the Intra MB mode and Intra prediction mode quickly.

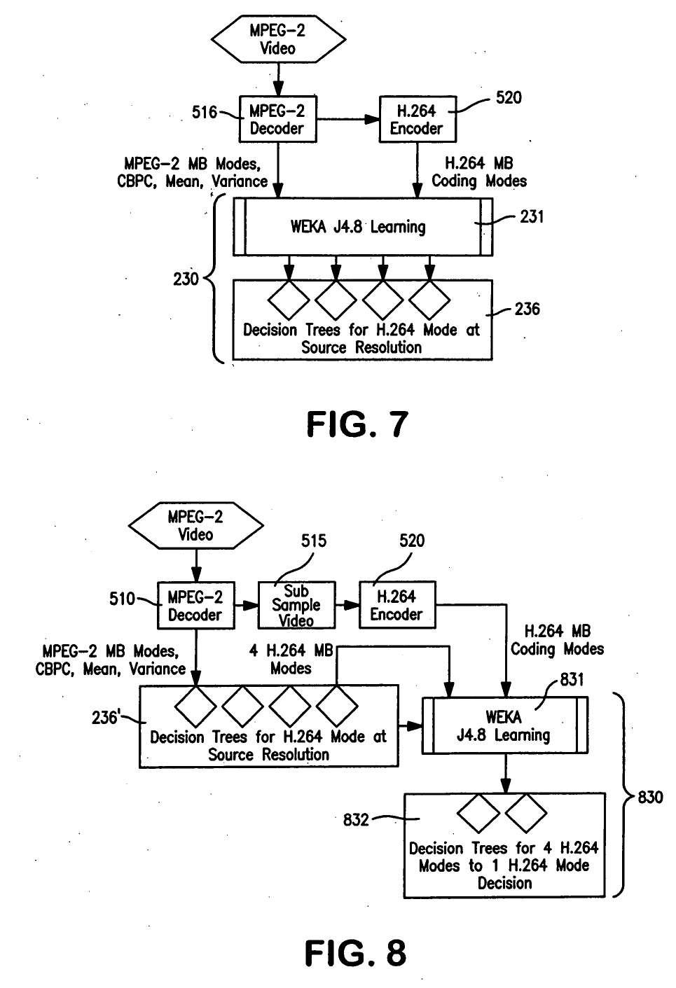

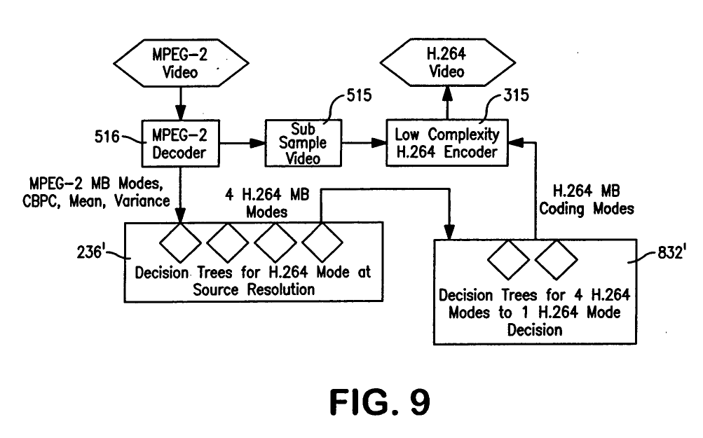

FIGS. 7-9 illustrate embodiments that employ mode reduction in the output domain. FIG. 7 shows the training/configuring stage for MROD, for a 1:1 decision (i.e., no resolution reduction in the input domain). In FIG. 8, a second phase of the training/configuring stage for MROD is implemented for a 4:1 decision; i.e., with 4 MB modes from the decision tree 236′ being used, in the learning routine 830 (comprising learning algorithm 831 and decision tree 832) to obtain one H.264 mode decision. FIG. 9 shows how the configured decision trees are used for MROD, with complexity reduction.

1. A method for receiving encoded MPEG-2 video signals and transcoding the received encoded signals to encoded H.264 reduced resolution video signals, comprising the steps of:
decoding the encoded MPEG-2 video signals to obtain frames of uncompressed video signals and to also obtain MPEG-2 feature signals;
deriving H.264 mode estimation signals from said MPEG-2 feature signals;
subsampling said frames of uncompressed video signals to produce subsampled frames of video signals; and
producing said encoded H.264 reduced resolution video signals using said subsampled frames of video signals and said H.264 mode estimation signals.

2. The method as defined by claim 1, wherein said MPEG-2 feature signals comprise macroblock modes and motion vectors.

3. The method as defined by claim 1, wherein said MPEG-2 feature signals comprise macroblock modes, motion vectors, DCT coefficients, and residuals.

4. The method as defined by claim 1, wherein said subsampling comprises implementing reduction in the number of pixels, both vertically and horizontally, by a multiple of two.

5. The method as defined by claim 1, wherein said step of deriving H.264 mode estimation signals from said MPEG-2 feature signals comprises providing a decision tree which receives said MPEG-2 feature signals and outputs said H.264 mode estimation signals.

6. The method as defined by claim 5, wherein said decision tree is configured using a machine learning method.

7. The method as defined by claim 1, further comprising reducing the number of mode estimation signals derived from said MPEG-2 feature signals.

8. The method as defined by claim 7, wherein said reduction in mode estimation signals is substantially in correspondence with said reduction in resolution resulting from said subsampling.

9. The method as defined by claim 7, wherein said reducing of the number of mode estimation signals is implemented by deriving a reduced number of mode estimation signals from a reduced number of MPEG-2 feature signals.

10. The method as defined by claim 9, wherein said deriving of the reduced number of MPEG-2 feature signals is implemented by using a subsampled residual from the decoding of the MPEG-2 video signals.

11. The method as defined by claim 7, wherein said reducing of the number of mode estimation signals is implemented by deriving an initial unreduced number of mode estimation signals, and then reducing said initial unreduced number of mode estimation signals.

12. The method as defined by claim 1, wherein said decoding, deriving, subsampling and producing steps are performed using a processor.

13. A method for receiving encoded first video signals, encoded with a first encoding standard, and transcoding the received encoded signals to reduced resolution second video signals, encoded with a second encoding standard, comprising the steps of:
decoding the encoded first video signals to obtain frames of uncompressed video signals and to also obtain first feature signals;
deriving second encoding standard mode estimation signals from said first feature signals;
subsampling said frames of uncompressed video signals to produce subsampled frames of video signals; and
producing said encoded reduced resolution second video signals using said subsampled frames of video signals and said second encoding standard mode estimation signals.

14. The method as defined by claim 15, wherein said second encoding standard is a higher compression standard than said first compression standard.

15. The method as defined by claim 13, wherein said first feature signals comprise macroblock modes and motion vectors.

16. The method as defined by claim 13, wherein said subsampling comprises implementing reduction in the number of pixels, both vertically and horizontally, by a multiple of two.

17. The method as defined by claim 13, wherein said step of deriving second encoding standard mode estimation signals from said first feature signals comprises providing a decision tree which receives said first feature signals and outputs said second encoding standard mode estimation signals.

18. The method as defined by claim 17, wherein said decision tree is configured using a machine learning method.

19. The method as defined by claim 13, further comprising reducing the number of second encoding standard mode estimation signals derived from said first feature signals.

20. The method as defined by claim 19, wherein said reduction in second encoding standard mode estimation signals is substantially in correspondence with said reduction in resolution resulting from said subsampling.

21. The method as defined by claim 19, wherein said reducing of the number of second encoding standard mode estimation signals is implemented by deriving a reduced number of second encoding standard mode estimation signals from a reduced number of first feature signals.

22. The method as defined by claim 21, wherein said deriving of the reduced number of first feature signals is implemented by using a subsampled residual from the decoding of the first video signals.

23. The method as defined by claim 19, wherein said reducing of the number of second encoding standard mode estimation signals is implemented by deriving an initial unreduced number of second encoding standard mode estimation signals, and then reducing said initial unreduced number of second encoding standard mode estimation signals.

24. The method as defined by claim 13, wherein said decoding, deriving, subsampling and producing steps are performed using a processor.
